(19) United States
(12) Patent Application Publication
(10) Pub. No.: US 2006/0250790 A1
(43) Pub. Date: Nov. 9, 2006

(54) Flashlight, flashlight light circuit and methods

(75) Inventors: Pat Y. Mah, Hong Kong (HK); Alexander Joseph Kalogroulis, Coulsdon (GB)

Correspondence Address: KLARQUIST SPARKMAN, LLP, 121 SW SALMON STREET, SUITE 1600, PORTLAND, OR, 97204, US

(73) Assignees: Daka Development Limited; Daka Reseach Inc.

(21) Appl. No.: 11/174,192

(22) Filed: Jul. 1, 2005

Related U.S. Application Data
(60) Provisional application No. 60/678,672, filed on May 5, 2005.

(51) Int. Cl. F21L 4/00

(52) U.S. Cl. 362/157

(57) ABSTRACT

Embodiments of a flashlight light circuit are described herein. According to one embodiment, there is a light element, at least two batteries coupled to the light element and electrically contactable with each other to activate the light element, and a switch selectively operable to move at least one of the two batteries to activate or deactivate the light element

### CROSS REFERENCE TO RELATED APPLICATION

This application claims the benefit of U.S. Provisional Patent Application No. 60/678,672, filed May 5, 2005, which is hereby incorporated by reference.

### FIELD

The present application is directed to flashlights, and more particularly to LED flashlights.

### BACKGROUND

Battery powered flashlights are known in the art. According to one conventional approach, flashlights using a light emitting diode (LED) as the light source and one or more coin cell batteries as the power source make use of the LED leads in switching the flashlight on and off. In these conventional flashlights, LED leads or other similar components are movable into and out of contact with the power source to complete the circuit and change the flashlight between “ON” and “OFF” modes. The leads or other components are often thin conductors that may wear, fatigue or break due to repeated movement between the “ON” and “OFF” positions over time. Furthermore, jarring or jostling of the flashlight due to repeated dropping or impact with other objects may affect the integrity of the electrical connections between the movable leads and the batteries.

It is therefore desirable to provide a battery powered flashlight that minimizes movement of electrical leads or similar components to establish contact with batteries to activate the flashlight. It is also desirable to keep the number of components in the flashlight at a minimum to reduce costs and improve reliability.

### SUMMARY

Disclosed below are representative embodiments that are not intended to be limiting in any way. Instead, the present disclosure is directed toward novel and nonobvious features, aspects, and equivalents of the embodiments of the flashlight and flashlight light circuit described below. The disclosed features and aspects of the embodiments can be used alone or in various novel and nonobvious combinations and sub-combinations with one another.

Moving flashlight components other than electrical leads to activate the flashlight can improve the integrity of the electrical connection between the batteries and the leads such that electrical connectivity within the flashlight can be better maintained over time. More specifically, the electrical leads and batteries are arranged such that relative motion and frictional engagement between the leads and the batteries can be minimized during activation and deactivation of the flashlight.

In one embodiment, a flashlight light circuit that includes a light element has at least two batteries coupled to the light element and electrically contactable with each other to activate the light element. The circuit further includes a switch selectively operable to move the two batteries to activate or deactivate the light element.

In some implementations, the switch operates the two batteries by moving at least one of them. In other implementations, the switch is selectively operable to separate the at least two batteries to deactivate the light element. In some implementations, the switch is selectively operable to move the at least two batteries together to activate the light element.

The flashlight can include elastomeric elements configured to urge the batteries apart to deactivate the light element. In still other implementations, the switch can include at least one magnet. The switch can be selectively operable to magnetize the batteries to activate or deactivate the light element.

In some implementations, the light element can include at least one light emitting diode (LED).

In one embodiment, a flashlight comprises a light element operable in an on mode and an off mode. The flashlight also comprises a first battery electrically coupled to the light element and a second battery coupled to the light element and contactable with the first battery to place the light element in the on mode. The flashlight can also include a switch member positionable to move the first and second batteries into electrical contact with each other to place the light element in the on mode or move the first and second batteries apart from each other to break electrical contact between the batteries to place the light element in the off mode.

In some implementations, the flashlight can include one or more magnets to attract or repel at least one of the first and second batteries. In some implementations, the first battery is stationary and the switch member moves the second battery to break electrical contact between the batteries.

In some implementations, the switch member can be pushable toward the first and second batteries to position the switch member between the first and second batteries to break electrical contact between the batteries and retractable away from the first and second batteries to allow electrical contact between the batteries.

In further implementations, the switch member can comprise a rotatable portion. Rotating the rotatable portion in a first direction can position the rotatable portion between the first and second batteries to break electrical contact between the first and second batteries.

In some implementations, the switch member can be stationary relative to the batteries. The batteries can be moved toward the switch member place the light element in the on or off mode. Further, the flashlight can include a housing configured to retain the batteries and the light element.

The flashlight can include at least one elastomeric element configured to urge the first and second batteries into electrical contact or urge the first and second batteries apart from and out of electrical contact with each other.

In some implementations, the flashlight comprises a housing configured to at least partially cover the batteries. The housing can have a shelf positionable between the first and second batteries to maintain a portion of the first and second batteries in spaced apart relation. The switch member can be made from a rigid material. The flashlight can further comprise a body coupling the housing and the switch member. The body can have a slot through which the switch member is extendable to engage the batteries.

In some implementations, the switch member can comprise an internal end configured to slide between the first and second batteries and an external end capable of being selectively pushed to insert the internal end between the first and second batteries and pulled to extract the internal end from between the first and second batteries. The internal end can comprise a wedge shape having first and second converging surfaces.

The first and second batteries can comprise coin cell batteries, other conventional batteries, or combinations thereof.

In one embodiment, a flashlight comprises a light element. The flashlight can also include a first battery electrically coupleable to a second battery to activate the light element. The flashlight can further include a switch member configured to selectively electrically decouple the first battery and the second battery by moving the batteries apart to deactivate the light element.

In some implementations, the switch member can be pushable toward the first and second batteries to position the switch member between the first and second batteries thus electrically decoupling the batteries by moving them apart and pullable away from the first and second batteries to extract the switch member from between the batteries to facilitate electrical coupling of the batteries.

In some implementations, the switch member can comprise a rotatable element having an engagement portion. Rotating the element in a first direction can position the engagement portion between the first and second batteries to move and electrically decouple the batteries. Rotating the element in a second direction can position the engagement portion away from the first and second batteries to allow electrical coupling of the batteries.

In some implementations, the switch member can be stationary relative to the batteries. The batteries can be moved toward the switch member to electrically decouple the batteries by moving them apart and the batteries can be moved away from the switch member to allow electrical coupling of the batteries. The flashlight can further include a housing that contains the batteries and a body to which the switch member is fixed. Movement of the housing away from the body can deactivate the light element.

In one embodiment, a flashlight circuit comprises at least one LED element having a first lead and a second lead. The flashlight can also include a first battery and a second battery each comprising a positive terminal surface and a negative terminal surface. The first lead is positioned to contact the positive terminal surface of the first battery and the second lead is positioned to contact the negative terminal surface of the second battery. A portion of the negative terminal surface of the first battery and a portion of the positive terminal surface of the second battery are contactable with each other to complete a circuit and activate the LED element. The flashlight can also include a switch member that is selectively movable into a position to move the first battery and the second battery relative to each other to either (1) urge contact between the negative terminal surface of the first battery and the positive terminal surface of the second battery to activate the light emitting diode; or (2) urge the negative terminal surface of the first battery and the positive terminal surface of the second battery away from each other to deactivate the light emitting diode. In some implementations, the flashlight includes a sleeve made from a non-conductive material wrapped around a portion of at least the second lead to protect the portion of the second lead from inadvertent electrical contact with the batteries.

A method of operating a flashlight can also include electrically connecting a light element to a battery, positioning the battery to complete a circuit and activate the light element, and selectively moving a switch in a first direction to move the battery to deactivate the light element. In some implementations, the method can also include selectively moving the switch in a second direction to move the battery to activate the light element. The method can also include magnetizing the battery to facilitate movement of the battery.

The foregoing and other features and advantages of the invention will become more apparent from the following detailed description, which proceeds with reference to the accompanying figures.

### BRIEF DESCRIPTION OF THE DRAWINGS

FIG. 1 is a perspective view illustrating one embodiment of a flashlight in accordance with the present application shown with an attached housing.

FIG. 2 is a perspective view of the flashlight of FIG. 1 shown without the housing.

FIG. 3 is an exploded view of the flashlight of FIG. 1.

FIG. 4 is a top plan view of the flashlight of FIG. 1.

FIG. 5A is a cross-sectional side view of the flashlight in the “ON” position taken along the line 5A-5A in FIG. 4.

FIG. 5B is a cross-sectional side view of the flashlight of FIG. 5A, except with the switch in the “OFF” position.

FIG. 6 is a side elevational view of the flashlight of FIG. 1.

FIG. 7A is a cross-sectional side view of one embodiment of a flashlight having a selector that urges batteries together, with the selector shown in the “OFF” position.

FIG. 7B is a cross-sectional side view of the flashlight of FIG. 7A, except with the selector in the “ON” position.

FIG. 8 is a cross-sectional side view of one embodiment of a flashlight having a magnet coupled to a selector, with the selector shown in the “OFF” position.

FIG. 9 is a cross-sectional side view of one embodiment of the flashlight having a magnet coupled to a housing and a selector shown in the “OFF” position.

FIG. 10 is a top plan view of one embodiment of a flashlight having a rotatable selector shown without an attachable housing.

FIG. 11 is a cross-sectional side view of one embodiment of a flashlight having a selectively removable housing.

### DETAILED DESCRIPTION

Described below are embodiments of a flashlight. Generally, the flashlight is operable by moving at least one battery to complete a circuit to activate the flashlight's light source and moving the at least one battery to break or disconnect the circuit to deactivate the flashlight's light source. In some of the described embodiments, there are two batteries, and each battery is moved to complete the circuit and to break the circuit. In other embodiments, only one or some of the batteries move during operation of the flashlight.

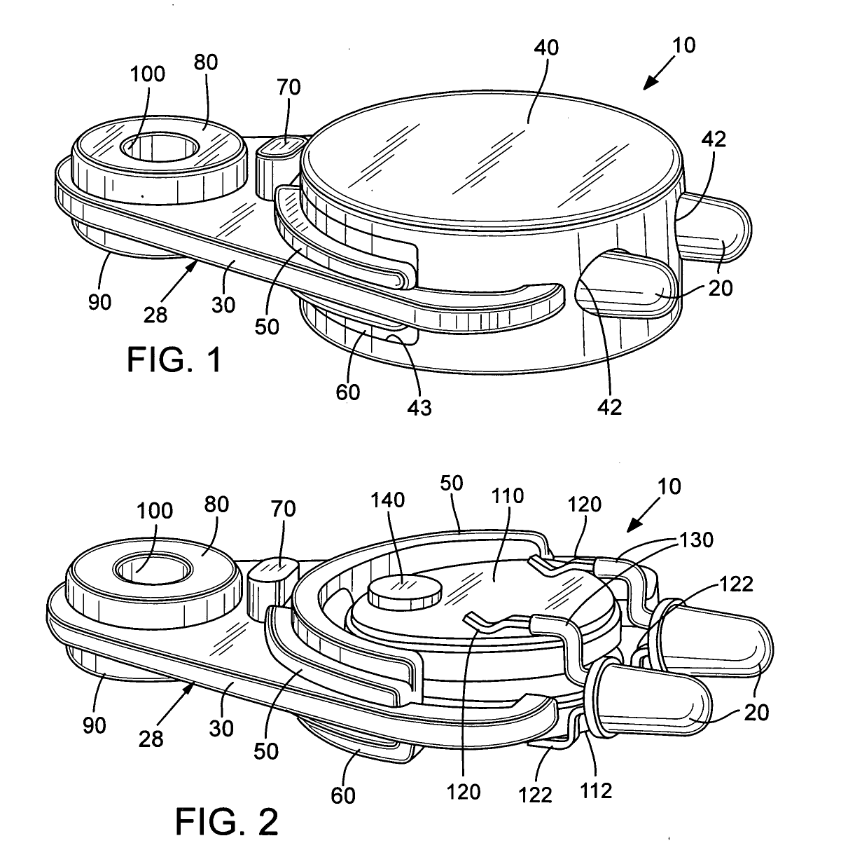

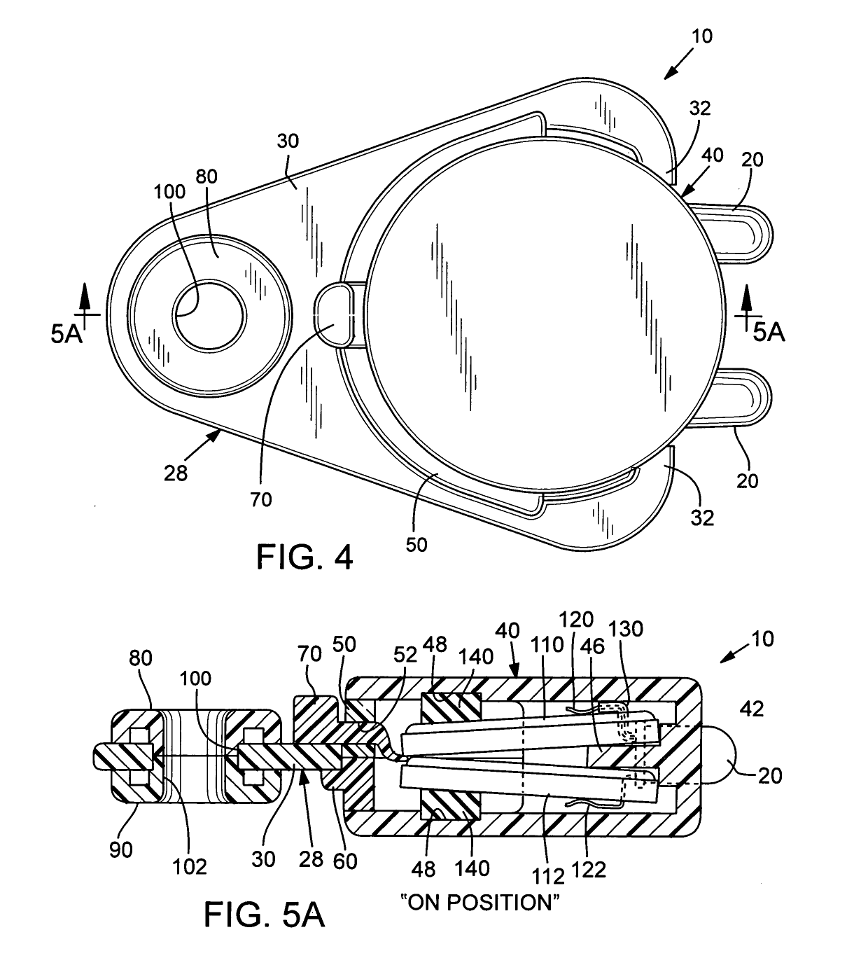

According to one embodiment, as illustrated in FIGS. 1-6, a flashlight is indicated generally at 10. The flashlight 10 includes a housing 40 having openings 42 through which light emitting components, such as light emitting diode (LED) elements 20 extend. Although the illustrated embodiment shows two openings 42 with one LED element 20 extending through each opening, it should be recognized that housing 40 can include one or more openings 40 through which one or more LED elements 20 extend.

The housing 40 is generally configured to encase and protect internal flashlight components (see FIG. 2). In certain embodiments, the housing 40 can be molded in a single monolithic construction. In other embodiments, the housing 40 can include two separately molded halves ultrasonically welded together.

The LED elements 20 can be conventional LED elements commonly used in the industry. Although LED elements are desirable as the light source component of the flashlight, other light emitting devices, such as conventional filament light bulbs, can be used together with or instead of LED elements.

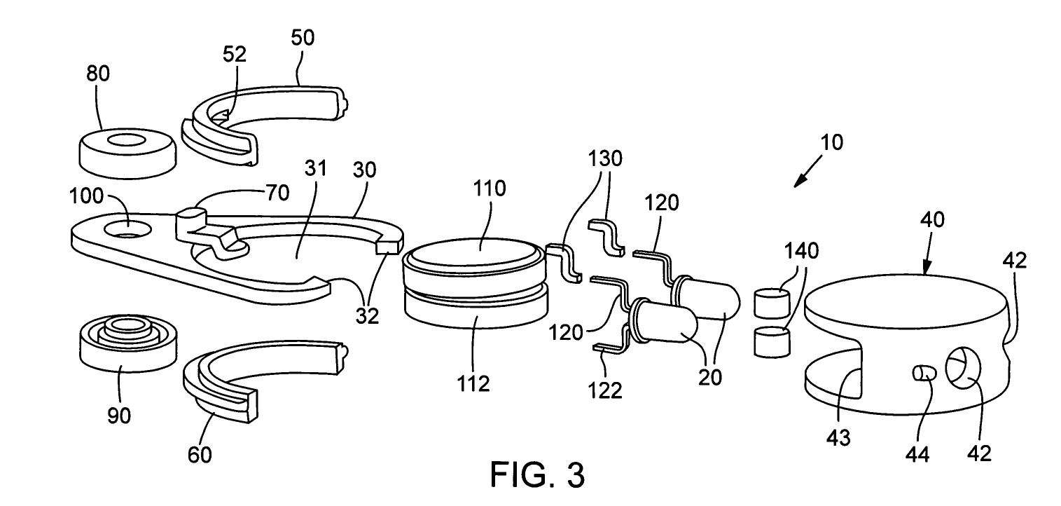

The flashlight 10 can include a body indicated generally at 28 that has a body frame 30, an upper spacer 50 and a lower spacer 60. The body frame 30 can be generally wishbone-shaped having two extending prongs defining a housing receiving area 31 between the prongs. The prongs are configured to extend at least partially around the housing 40 and include tabs 32 that engage a recess, or opening 44 (see FIG. 3), formed in the housing to at least partially retain the housing to the body 28.

As best shown in FIGS. 1 and 6, the upper spacer 50 includes a shelf extending at least partially around its outer periphery to engage an upper surface of the body frame 30 such that the spacer 50 rests on the upper surface without passing through the housing receiving area 31. Similarly, the lower spacer 60 includes a shelf extending at least partially around its outer periphery to engage a lower surface of the body frame 30 such that the spacer 60 rests on the lower surface without passing through the housing receiving area 31. The spacers 50, 60 can be configured to occupy openings or gaps in the housing 40 formed during manufacturing of the housing. For example, the spacers 50, 60 are configured to be received at least partially within a slotted opening 43 of the housing 40 when the housing is coupled to the body 28 to retain the spacers to the body.

The housing receiving area of the body frame 30 and the housing 40 are sized to allow a substantial portion of at least two batteries to be positioned therein. As shown in FIG. 2, a first battery 110 and a second battery 112 arranged in a generally “stacked” formation are positioned within the housing receiving area of the body frame 30. The housing 40 (not shown in FIG. 2) is configured to receive and surround the batteries when coupled to the body 28. The batteries are in a stacked formation in that the first battery 110 as shown in FIG. 2 is positioned substantially directly above the second battery 112.

Generally, the batteries provide the power to operate the flashlight circuit and activate the LED elements 20, i.e., to cause the LED elements to emit light. As shown in the illustrated embodiments, desirably the batteries 110, 112 are conventional coin cell batteries because of their compact design and generally smaller size. A typical coin cell battery is shaped such that its diameter is greater than its height. Coin cell batteries are also known as “button” batteries and “miniature” batteries. Although the batteries used are desirably coin cell batteries, it is recognized that other types of batteries can also be used.

A basic coin cell battery is made up generally of a cathode can containing a cathode, an anode can containing an anode, an insulator electrically insulating the anode can from the cathode can and a separator positioned between and separating the cathode and anode. The anode forms a negative terminal or pole and the cathode forms a positive terminal or pole. The anode can and the cathode can each define an electrically contactable surface. In use, the coin cell battery provides power to an LED element by electrically connecting the negative terminal of the battery to a negative lead of the LED element and electrically connecting the positive terminal of the battery to a positive lead of the LED element.

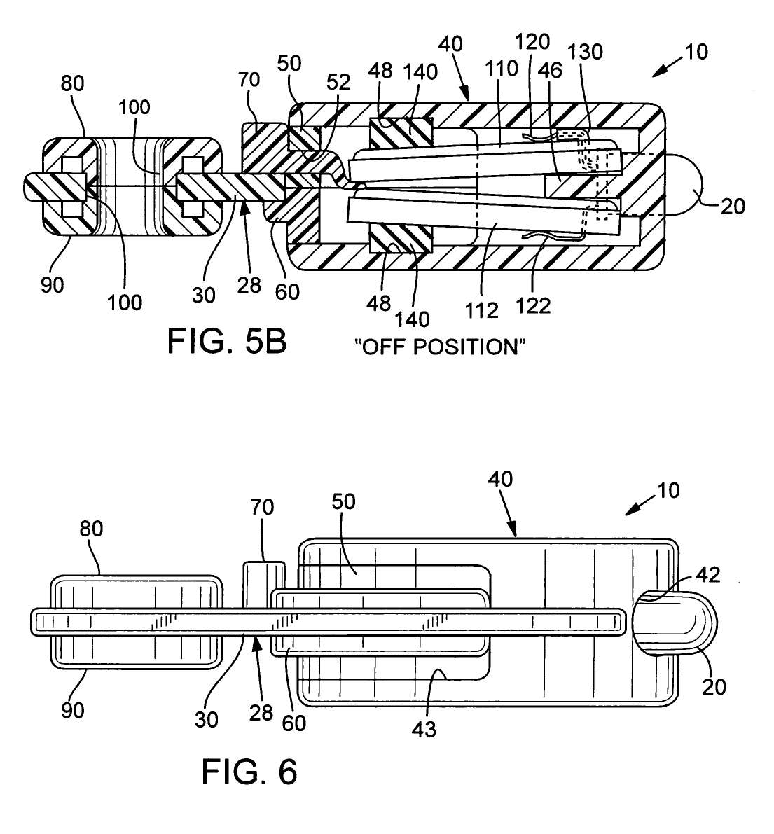

The housing 40 includes a battery separating shelf 46 (see FIGS. 5A and 5B) positioned between and at least partially separating the batteries 110, 112. In assembly, the battery 110 is positioned within the housing 40 such that a portion of the battery 110 rests on an upper surface of the shelf 46 as illustrated. Similarly, the battery 112 is positioned within the housing 40 such that a portion of the battery 112 rests on a lower surface of the shelf 46 as illustrated. The respective portions of the batteries 110, 112 resting on the shelf 46 can be described generally as non-contacting portions.

The shelf 46 extends in an inwardly radial direction away from an inner circumferential edge of the housing 40. Preferably, the shelf 46 extends away from the inner circumferential edge of the housing 40 extends no further than the respective central axes of the batteries 110, 112 when the batteries are positioned within the housing. In this way, the shelf is positioned between the batteries such that the batteries can be angled to contact each other at contactable portions of the batteries generally opposing the non-contacting portions of the batteries.

The batteries 110, 112 are stacked such that the respective positive terminal surfaces of the batteries are facing the general same direction and the respective negative terminal surfaces of the batteries are facing the general same direction. Accordingly, in the described embodiments, the contactable portions of the batteries include a portion of the positive terminal of battery 110 and a portion of the negative terminal of battery 112.

Each LED element 20 can include a negative lead 120 and a positive lead 122. The negative lead 120 is configured to remain in constant electrical contact with the negative terminal of battery 110, and the positive lead 122 is configured to remain in constant electrical contact with the positive terminal of battery 112. In some embodiments, insulating sleeves 130 can be formed around a portion of the negative leads 120, positive leads 122, or both, to insulate the leads from inadvertent electrical contact with the batteries or other conductive components.

As shown in FIG. 5A, when the contactable portions of the batteries are in contact with each other, i.e., electrically coupled to each other, a closed or completed electrical circuit is formed. Once the circuit is closed, electrical current flows from the positive terminal of battery 112 through the positive lead 122 and into the LED element 20. The current continues to flow out of the LED element 20 through the negative lead 120 to the negative terminal of battery 110. The current flow within the closed circuit results in activation of the LED element 20 to place the flashlight in an “ON” mode.

As shown in FIG. 5B, when the contactable portions of the batteries are not in electrical contact with each other, an open, disconnected or broken electrical circuit is formed to prevent electrical current flow through the circuit to deactivate the LED element 20 and place the flashlight in an “OFF” mode.

As shown in FIGS. 1-6, the flashlight 10 can include a selector, such as a movable switch 70, configured to selectively separate the contactable portions of the batteries 110, 112 such that electrical contact between the batteries is prevented. The switch 70 has an external end outside of the housing 40 configured to facilitate moving, e.g., pushing and pulling, of the switch and an internal end within the housing configured to extend through a slot 52 formed in the upper spacer 50 and facilitate insertion of the switch between the batteries 110, 112.

The external end can have a protruding tab designed to allow a user to simply move, or push, the switch 70 into an “OFF” position to place the flashlight in the “OFF” mode, and move, or pull, the switch into a an “ON” position, to place the flashlight in the “ON” mode.

The internal end of the switch 70 can be generally wedge-shaped with two converging surfaces. As the switch 70 is pushed into the “OFF” position, the internal end of the switch engages the batteries 110, 112 in contact with each other and the wedge-shaped internal end acts to split, or separate, the batteries such that electrical contact between the contactable portions of the batteries is restricted. Without contact between the contactable portions of the batteries 110, 112, the electrical circuit formed between the batteries and the LED element 20 is opened, or disconnected, and the LED element is deactivated, i.e., does not emit light, to place the flashlight 10 in the “OFF” mode. As the switch 70 is pulled from the “OFF” position into the “ON” position, the internal end of the switch is removed from between the batteries 110, 112 to reinstate electrical contact between the batteries and close, or complete, the electrical circuit thus activating the LED element 20 to place the flashlight 10 in the “ON” mode.

As best shown in FIGS. 2, 3, 5A, 5B, in some embodiments, the flashlight can also include elastomeric elements 140 positioned between the housing 40 and the batteries 110, 112 to bias the contactable portions of the batteries against each other, e.g., remain in electrical contact with each other. In some embodiments, the elastomeric elements 140 are retained between the housing and the batteries by recesses 48 formed in the housing 40 and configured to receive the elastomeric elements (see FIGS. 5A and 5B). Although two elastomeric elements 140 are shown in the illustrated embodiments, it is recognized that fewer or greater than two elements can be used. The elastomeric elements 140 can be made from any elastic material capable of providing a biasing force, such as rubber or plastic. Additionally, elastomeric elements 140 can be spring-type devices such as coil springs, compression springs or torsion springs. The elastomeric elements 140 are configured to deform as the biasing force is overcome by the selector engaging the batteries to allow the batteries to move out of contact with each other.

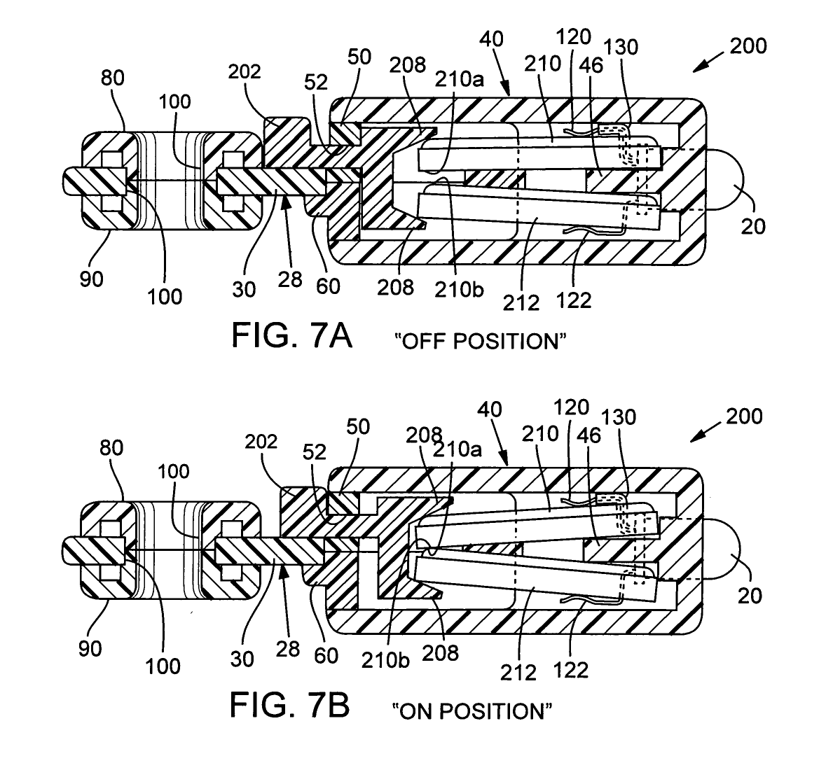

In some embodiments, a flashlight can have a selector that, instead of moving batteries apart to deactivate the flashlight, moves batteries together to activate the flashlight. According to one specific embodiment, and referring to FIGS. 7A and 7B, flashlight 200 includes a selector, such as switch 202, configured to selectively move the batteries 110, 112 into electrical contact with each other.

Like the switch 70 shown in FIGS. 1-6, the switch 202 has an external end outside of the housing 206 configured to facilitate movement the internal end within the housing. The external end can have a protruding tab and the internal end can have one or more biasing elements 208. As shown in the “OFF” position in FIG. 7A and the “ON” in FIG. 7B, the switch 202 has two biasing elements 208 each configured to engage one of the batteries 110, 112 and urge it toward the other. The biasing elements 208, which can be made of a partially elastic, resilient material, are configured to deform from their original position upon engagement with the batteries to apply a downwardly directed force to battery 110 and an upwardly directed force to battery 112. The opposing forces act to move the batteries toward and into contact with each other (see FIG. 5B). The biasing elements 208 can include an angled tip to facilitate engagement with the batteries.

Referring to FIGS. 7A and 7B, in embodiments of a flashlight, such as flashlight 200, having a selector, such as switch 202, that moves the batteries into contact with each other, the flashlight can include one or more elastomeric elements 204 positioned between the batteries 110, 112 to bias the contactable portions of the batteries away from each other. Like the elastomeric elements 140 of FIGS. 1-6, the elastomeric elements 204 are configured such that the biasing force of the elastomeric elements is overcome as the selector engages the batteries to allow the batteries to move into physical contact with each other at contact portions 210a, 210b to complete the flashlight circuit.

In some embodiments, the switches 70, 202 can be push-push switches configured to allow a user to push the switches into the “OFF” position to place the flashlight in the “OFF” mode, and push the switches again into the “ON” position to place the flashlight in the “ON” mode. Alternatively, the switches 70, 202 can be pull-pull switches allowing a user to selectively pull the switches into the “OFF” position and pull the switches again into the “ON” position.

In some embodiments, the flashlight can have a source of magnetism used in the switching operation. In some embodiments, the flashlight can include one or more batteries comprised of a ferromagnetic material, such as iron, cobalt or nickel, and at least partially movable by magnetic attraction or repulsion.

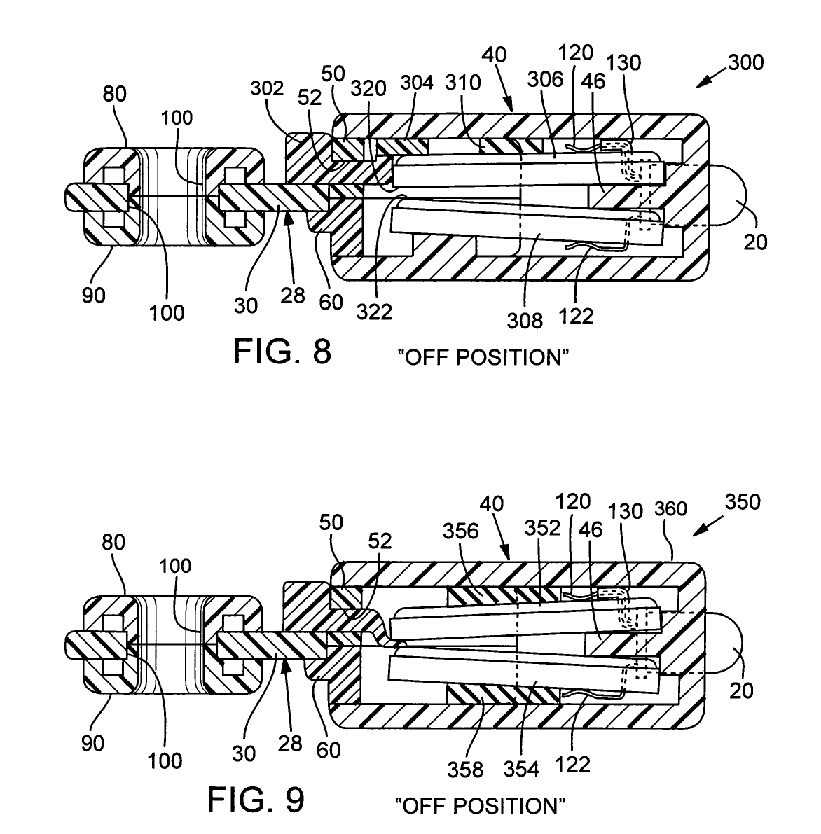

For example, as shown in FIG. 8, in one implementation, a flashlight 300 includes a selector, e.g., switch 302, having a magnet 304 and a first battery 306 that can be moved into physical contact with a second battery 308 to close the flashlight circuit and activate the flashlight, i.e. place the flashlight in the “ON” mode. As illustrated, the second battery 308 can be fixed and the first battery 306 can be capable of movement relative to the second battery. The switch 302 can be selectively movable to place the magnet 304 in close proximity to the first battery 306 such that a magnetic field generated by the magnet 304 urges the first battery towards the magnet and away from the second battery 308 to open the flashlight circuit and deactivate the flashlight, i.e., place the flashlight in the “OFF” mode.

In other implementations, the second battery 308 can also be movable, such that the first and second batteries 306, 308 are movable relative to each other. The selector can be a switch similar to switch 302, but modified to include a first magnet and a second magnet. The switch can be selectively movable to place the first magnet in close proximity to the first battery and the second magnet in close proximity to the second battery. In this position, the magnetic fields generated by the respective magnets urge the first battery toward the first magnet and the second battery toward the second magnet to separate the two batteries and deactivate the flashlight.

Referring again to FIG. 8, the flashlight 300 can include an elastomeric element 310 positioned between housing 312 and the first, or movable, battery 306 to bias a contactable portion 320 of the battery 306 to contact a contactable portion 320 of the second, or fixed, battery 308. In operation, as the switch 302 is moved such that the magnet 304 is positioned proximate the first battery 306, the attractive force between the magnet 304 and the first battery 306 overcomes the biasing force of the elastomeric element 310 to move the first battery 306 out of electrical contact with the second battery 308. Also, in implementations having a second battery that is movable, an elastomeric element can be positioned between the housing and the second battery to provide similar biasing effects.

In some implementations, as shown in FIG. 9, a flashlight 350 can include a first battery 352 and a second battery 354 that are movable relative to each other and comprised of a ferromagnetic material, and a first magnet 356 and a second magnet 358 attached to an interior portion of a housing 360 of the flashlight. The magnets 356, 358 are configured and positioned within the housing 360 to generate a magnetic field to magnetize or polarize the batteries 352, 354, respectively. Depending on the orientation of the magnets, the batteries can be magnetized to repel or attract each other.

According to one specific implementation also shown in FIG. 9, the magnets 356, 358 are oriented and positioned to urge the batteries 352, 354 to attract to and contact each other to complete the flashlight circuit and activate the flashlight. A selector, e.g., switch 362, configured to function much like the switch 70 of FIGS. 1-6, can be selectively inserted between the batteries to break the circuit and deactivate the flashlight.

In another specific implementation, the magnets can be oriented and positioned to urge the batteries to repel and separate from each other to deactivate the flashlight. The selector can have a configuration similar to selector 202 of FIGS. 7A and 7B to selectively control engagement with the batteries and overcome the repulsion force of the batteries to bring the batteries into physical contact, thus closing the circuit and activating the flashlight.

In some implementations, a flashlight can have one or more permanently magnetized batteries. A permanently magnetized battery can be defined as any magnetizable battery that is capable of generating a magnetic field of appreciable magnitude exclusive of any external magnetic field source. The flashlight can include a selector that is selectively operable to move a magnet into a position proximate a movable permanently magnetized battery. The selector is similar to the selector 302 of FIG. 8, except that the magnet is oriented to produce a magnetic field that repels the magnetized battery away from the magnet and toward a second battery to facilitate electrical coupling of the magnetized battery and the second battery, thereby activating the flashlight. In specific implementations, the second battery can be a non-magnetized battery that is fixed relative to the movable permanently magnetized battery. The flashlight can also include one or more elastomeric elements positioned between the batteries to bias the batteries apart from each other.

In some implementations, the flashlight can include a selector that is selectively operable to move a first magnet into a position proximate a first movable permanently magnetized battery and a second magnet into a position proximate a second movable permanently magnetized battery. The first and second batteries are oriented such that they repel each other to deactivate the flashlight. The selector can be positioned such that the first and second magnets are proximate the batteries. In this position, the first and second magnets are oriented to produce a magnetic field strong enough to overcome the repulsion between the batteries and repel the batteries toward and into physical contact with each other to activate the flashlight.

In some embodiments of a flashlight having at least two permanently magnetized batteries, the batteries can be oriented to either repel or attract each other.

In implementations having magnetized batteries oriented to attract each other, the magnetic fields produced by the batteries urge the batteries into electrical contact with each other to activate the flashlight. The flashlight can have a selector, like the switch 70, to separate or space apart the batteries to deactivate the batteries.

Similarly, in implementations having magnetized batteries oriented to repel each other, the magnetic fields produced by the batteries urge the batteries apart and out of electrical contact with each other to deactivate the flashlight. The flashlight has a selector, like the switch 202 to apply a pressure to the batteries to overcome the repulsion force between the batteries to bring the batteries into electrical contact and activate the flashlight.

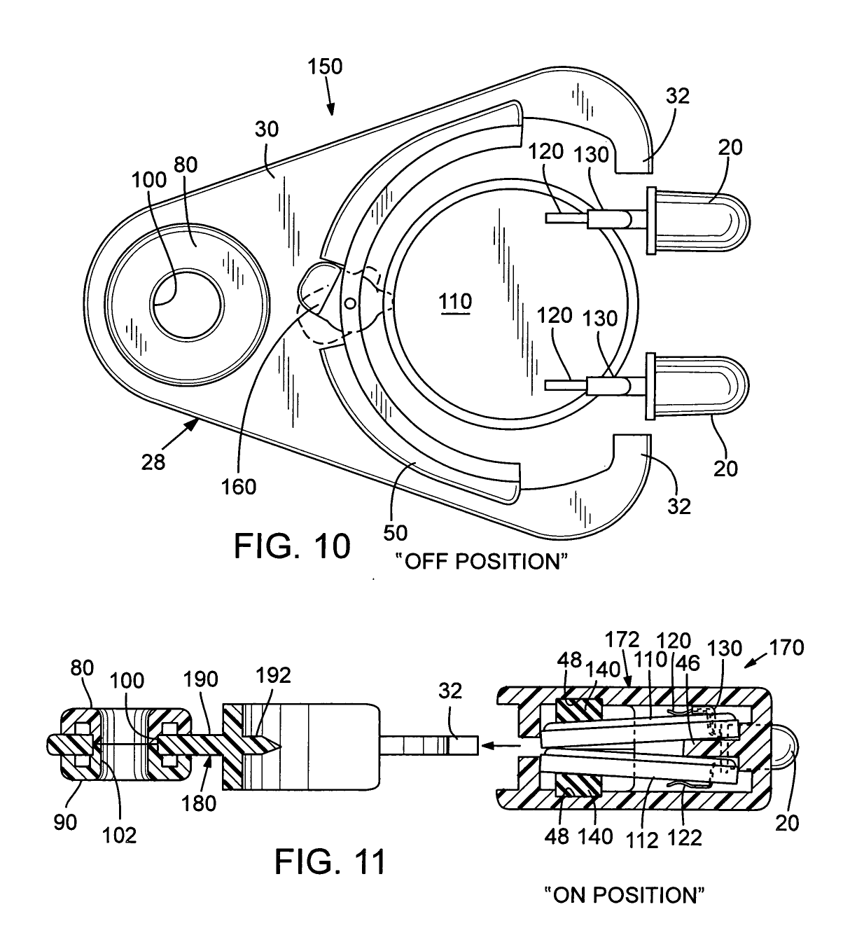

As shown in FIG. 10, in an embodiment of a flashlight 150 shown with the housing removed, the selector includes a rotatable switch 160. Similar to the switch 70, the rotatable switch 160 can include a tab designed to allow the user to simply rotate the selector between the “ON” and “OFF” positions. A portion of the rotatable switch 160 can be configured to extend through a slot (not shown) formed in the upper spacer 50.

In some implementations, the rotatable switch 160 can be configured to selectively separate the contactable portions of the batteries 110, 112 by rotating the rotatable switch from an “ON” position to an “OFF” position. A portion of the rotatable switch 160 can be positionable between the contactable portions of the batteries when the rotatable switch is in the “OFF” position.

In some implementations, the rotatable switch 160, like the switch 202 in FIGS. 7A and 7B, can be configured to selectively move together contactable portions of the batteries by rotating the rotatable switch from an “OFF” position to and “ON” position.

In some implementations where one or more of the batteries are magnetized, the rotatable switch 160 can be configured to either selectively separate or bring together the batteries, and/or facilitate magnetization of the batteries to urge the batteries together or apart, by rotating the rotatable switch.

Now referring to FIG. 11, an embodiment of a flashlight 170 includes a selectively removable housing 172 configured to retain the batteries 110, 112. When the housing 172 is removed from a flashlight body 180, as shown in FIG. 11, a portion of the batteries 110, 112 are separated by shelf 46 formed in the housing and a portion of the batteries are in electrical contact. Accordingly, the housing 172 can be removed from the body 180 of the flashlight 10 to close the circuit between the batteries 110, 112 and the LED element 20 thus activating the LED element 20 and placing the flashlight in the “ON” mode.

The body can include a body frame 190 with a fixed selector 192. The fixed selector 192 includes a battery engaging portion configured to facilitate separation of the contactable portions of the batteries 110, 112. In certain embodiments, the battery engaging portion is wedge shaped similar to the internal end of the switch 70 of the described embodiments.

As the housing 172 is attached to the body 180, the contactable portions of the batteries 110, 112 engage the battery engaging portion of the fixed selector 192 to urge the batteries to separate, thereby opening the electrical circuit between the batteries and LED element 20 to place the flashlight in the “OFF” mode. Accordingly, the housing 172 can be attached to the body 180 to deactivate the LED element 20. As can be recognized, a user can simply remove the housing 172 from the body 180 to use the flashlight and attach the housing to the body when use of the flashlight is no longer desired.

Although the illustrated embodiment shows a fixed selector configured to separate the batteries, in some embodiments, the fixed selector can be configured to urge the batteries together such that removal of the housing from the body deactivates the LED element and attachment of the housing to the body activates the LED element. Further, in some embodiments, magnets or magnetized batteries, such as described above, can be used in conjunction with a fixed selector and removable housing configuration.

In some embodiments, a flashlight can include other components. For example, as shown in FIGS. 1-6, the flashlight 10 includes a keychain opening 100 formed in the body frames 30, 190 to facilitate securing the flashlight. The keychain opening 100 can include reinforcing eyelet members, such as an upper eyelet 80 coupled to a lower eyelet 90. As best shown in FIGS. 5A, 5B, the eyelets 80, 90 are coupled to each other by respective portions extending at least partially through the keychain opening 100. The portions can define a reinforced keychain opening 102 for providing support against stresses caused by the keychain or other devices attached to the flashlight.

In some embodiments, one or more of the body frame 30, upper spacer 50, lower spacer 60, upper eyelet 80, lower eyelet 90, selector and housing 40 are made from a rigid plastic or other rigid non-conductive material. In certain embodiments, the body frame 30 can be made from a metal and the upper and lower spacers 30, 50 can be used to insulate the batteries from the body frame. In specific embodiments where the body frame 30 is made from a plastic, the upper spacer 50 and lower spacer 60 can be integrated into the frame to form a monolithic one-piece construction (see, e.g., body frame 190 in FIG. 11).

It can be appreciated from the foregoing that in some embodiments of the flashlight having fewer and compact components, the flashlight can be a pocket-sized, hand-held, and/or portable flashlight.

In the illustrated embodiments, flashlights having two batteries are shown, and actuation of the flashlights involves movement of at least one of the batteries. Many of the same concepts apply to a flashlight with one battery, e.g., the battery 110, and, substituted for the battery 112, a conductor (e.g., a wire, strip or similar conductive member) with the same connections and end geometry as the battery 112. In this way, movement of at least one battery, i.e., movement of the battery 110 relative to the conductor in place of the battery 112, or movement of the battery 110 and the conductor, can effect actuation of the flashlight.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A flashlight light circuit comprising:
a light element;
at least two batteries operatively connected to the light element and electrically contactable with each other to activate the light element; and
a switch selectively operable to move at least one of the two batteries to activate or deactivate the light element.

2. The flashlight light circuit of claim 1, wherein the switch is selectively operable to separate the at least two batteries to deactivate the light element.

3. The flashlight light circuit of claim 2, further comprising at least one elastomeric element configured to urge the first and second batteries together to activate the light element.

4. The flashlight light circuit of claim 1, wherein the at least two batteries comprise a first battery and a second battery, and wherein the switch moves at least the first battery to separate the first and the second batteries from each other and deactivate the light element.

5. The flashlight light circuit of claim 1, wherein the light element includes at least one light emitting diode (LED).

6. The flashlight light circuit of claim 1, wherein the switch is selectively operable to move the at least two batteries together to activate the light element.

7. The flashlight light circuit of claim 6, further comprising at least one elastomeric element configured to urge the first and second batteries apart to deactivate the light element.

8. The flashlight light circuit of claim 1, further comprising at least one magnet configured to attract or repel at least one of the two batteries.

9. The flashlight light circuit of claim 1, wherein at least one of the two batteries comprises a magnetized battery.

10. A flashlight comprising:
a light element operable in an on mode and an off mode;
first and second batteries coupled to the light element and electrically contactable with each other to place the light element in the on mode; and
a switch member positionable (1) to move the first and second batteries into electrical contact with each other to place the light element in the on mode; or (2) move the first and second batteries apart from each other to break electrical contact between the batteries to place the light element in the off mode.

11. The flashlight of claim 10, further comprising one or more magnets to attract or repel at least one of the first and second batteries.

12. The flashlight of claim 10, wherein the switch member is manually urged toward the first and second batteries to position the switch member between the first and second batteries to break electrical contact between the batteries and is retracted away from the first and second batteries to allow electrical contact between the batteries.

13. The flashlight of claim 10, wherein the switch member comprises a rotatable portion.

14. The flashlight of claim 13, wherein rotating the portion in a first direction positions the portion between the first and second batteries to separate and break electrical contact between the first and second batteries.

15. The flashlight of claim 10, wherein the switch member is stationary, and wherein the batteries are movable relative to the switch member to place the light element in the on or off mode.

16. The flashlight of claim 15, further comprising a housing configured to retain the batteries and the light element.

17. The flashlight of claim 10, wherein the first battery is stationary, and wherein the switch member moves the second battery to break electrical contact between the batteries or allow electrical contact between the batteries.

18. The flashlight of claim 10, wherein the light element includes at least one light emitting diode (LED).

19. The flashlight of claim 10, further comprising at least one elastomeric element configured to either urge the first and second batteries into electrical contact with each other or urge the first and second batteries apart from and out of electrical contact with each other.

20. The flashlight of claim 10, further comprising a housing configured to at least partially cover the batteries, the housing having a shelf positionable between the first and second batteries to maintain a portion of the first and second batteries in spaced apart relation and out of electrical contact with each other.

21. The flashlight of claim 10, wherein the switch member is made from a rigid material.

22. The flashlight of claim 20, further comprising a body coupling the housing and the switch member, the body having a slot through which the switch member is extendable to engage the batteries.

23. The flashlight of claim 10, wherein the switch member comprises an internal end configured to slide between the first and second batteries and an external end capable of being selectively pushed to slide the internal end between the first and second batteries and pulled to retract the internal end from between the first and second batteries.

24. The flashlight of claim 23, wherein the internal end comprises a wedge shape having first and second converging surfaces.

25. The flashlight of claim 10, wherein the first and second batteries comprise coin cell batteries.

26. A flashlight comprising:
a light element;
a first battery electrically connectible to a second battery to activate the light element; and
a switch member configured to facilitate relative movement between the first and second batteries, wherein moving the batteries apart deactivates the light element.

27. The flashlight of claim 26, wherein the switch member is pushable toward the first and second batteries to position the switch member between the first and second batteries thereby electrically decoupling the batteries by moving them apart and pullable away from the first and second batteries to extract the switch member from between the batteries to facilitate electrical coupling of the batteries.

28. The flashlight of claim 26, wherein the switch member comprises a rotatable element having an engagement portion.

29. The flashlight of claim 28, wherein rotating the element in a first direction positions the engagement portion between the first and second batteries to move and electrically decouple the batteries, and rotating the element in a second direction positions the engagement portion away from the first and second batteries to allow electrical coupling of the batteries.

30. The flashlight of claim 26, wherein the batteries are positionable remote from the switch member to allow electrical coupling of the batteries, and wherein movement of the batteries from a position remote from the switch member to a position in which the switch member engages the batteries causes electrical decoupling of the batteries.

31. The flashlight of claim 30, further comprising a housing and a body, wherein the batteries are contained within the housing and the switch member is fixed to the body, and wherein movement of the housing away from the body deactivates the light element.

32. A flashlight circuit comprising:
at least one light emitting diode element comprising a first lead and a second lead;
a first battery and a second battery each comprising a positive terminal surface and a negative terminal surface, wherein the first lead is positioned to contact the positive terminal surface of the first battery and the second lead is positioned to contact the negative terminal surface of the second battery, and wherein a portion of the negative terminal surface of the first battery and a portion of the positive terminal surface of the second battery are contactable with each other to complete a circuit and activate the light emitting diode element; and
a switch member selectively movable into a position to move the first battery and the second battery relative to each other to either (1) urge contact between the negative terminal surface of the first battery and the positive terminal surface of the second battery to activate the light emitting diode; or (2) urge the negative terminal surface of the first battery and the positive terminal surface of the second battery away from each other to deactivate the light emitting diode.

33. The flashlight of claim 32, further comprising a sleeve made from a non-conductive material wrapped around a portion of at least the second lead to protect the portion of the second lead from inadvertent electrical contact with the batteries.

34. A method of operating a flashlight comprising:
electrically connecting a light element to a battery;
positioning the battery to complete a circuit and activate the light element; and
selectively moving a switch in a first direction to move the battery to deactivate the light element.

35. The method of claim 34, further comprising selectively moving the switch in a second direction to move the battery to activate the light element.

36. The method of claim 34, further comprising using a magnetic force to move the battery.
